(19) United States
(12) Patent Application Publication
(10) Pub. No.: US 2007/0213906 A1
(43) Pub. Date: Sep. 13, 2007

(54) Work vehicle software application display management system and associated method

(75) Inventor: James Leonard Montgomery, Dubuque, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/374,405

(22) Filed: Mar. 13, 2006

(51) Int. Cl. G06F 19/00

(52) U.S. Cl. 701/50

(57) ABSTRACT

Software in the form of operating instructions may be stored on a computer-readable medium for use with a work vehicle. The operating instructions, when executed by a processor, cause the processor to control display of various applications catergorized into multiple application groups on a display screen of the work vehicle. An associated method is disclosed.

### FIELD OF THE DISCLOSURE

The present disclosure relates to management of display of software applications on the display screen of a work vehicle.

### BACKGROUND OF THE DISCLOSURE

Management of information onboard work vehicles (e.g., construction vehicles, forestry vehicles, or agricultural vehicles) can be rather involved as work vehicles and their operation become more and more complex. Work vehicle operators may welcome assistance with the information management task.

### SUMMARY OF THE DISCLOSURE

Software in the form of operating instructions may be stored on a computer-readable medium for use with a work vehicle. The operating instructions, when executed by a processor, cause the processor to control display of various applications on a display screen of the work vehicle. More particularly, the operating instructions, when executed by a processor, cause the processor to switch which application is in focus on the display screen of the work vehicle between applications of a selected application group of multiple application groups stored in a memory of the work vehicle according to a predetermined switching order in response to actuation of an input device, each application group comprising multiple applications, and switch which application group is the selected application group between application groups of the multiple application groups stored in the memory of the work vehicle in response to actuation of the input device.

By dividing the applications into different application groups, related applications can be grouped into logical, user-friendly categories. Moreover, such categories and applications thereof can be differentiated and selected by the operator upon operation of the input device (e.g., a button on a joystick at the operator's station) in predetermined manners, thereby providing ready access and management of information to the operator of the work vehicle. An associated method is disclosed.

The above and other features will become apparent from the following description and the attached drawings.

### BRIEF DESCRIPTION OF THE DRAWINGS

The detailed description of the drawings refers to the accompanying figures in which:

FIG. 1 is a perspective view of a work vehicle exemplarily configured as a crawler dozer,

FIG. 2 is a simplified diagram of a software application display management system onboard the work vehicle;

FIG. 3 is a flowchart of an exemplary control routine for managing display of software applications on the display screen;

FIG. 4 is a perspective view showing a joystick with a number of control buttons one of which may be used as an input device of the onboard management system;

FIG. 5 is a flowchart of an exemplary control routine;

FIG. 6 is a simplified block diagram of a controller network of the work vehicle; and

FIG. 7 is an elevation view showing a display screen of the work vehicle.

### DETAILED DESCRIPTION OF THE DRAWINGS

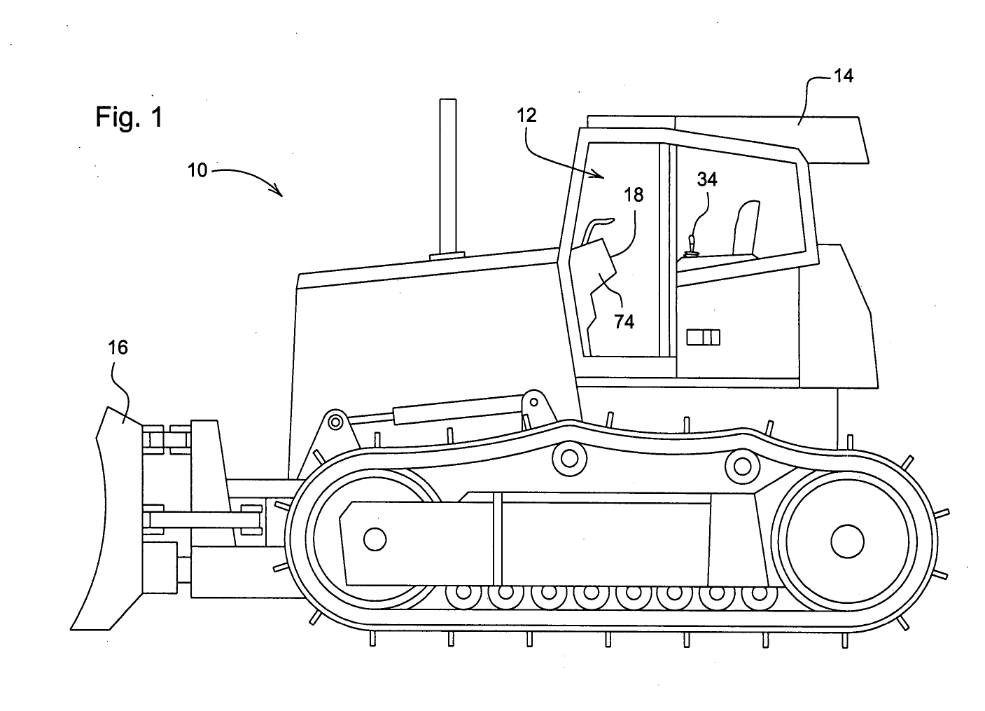

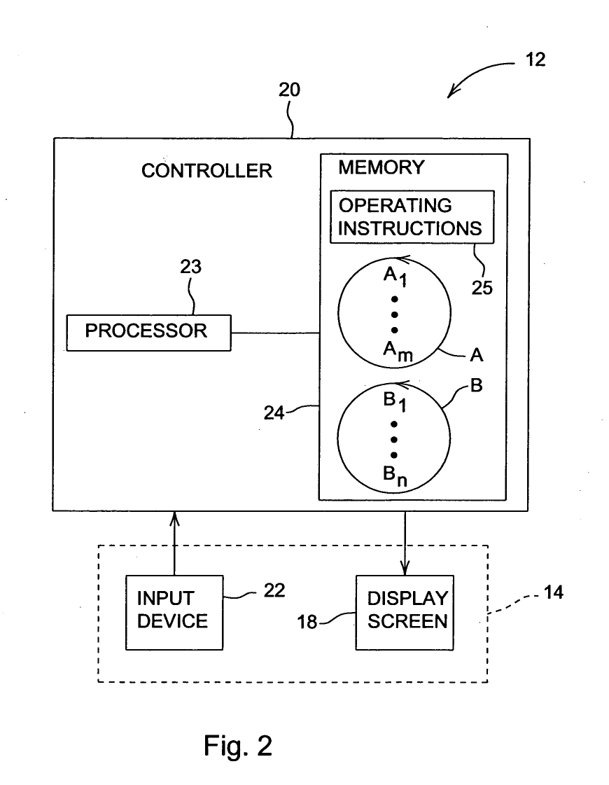

Referring to FIGS. 1 and 2, a work vehicle 10 has a software application display management system 12 for managing display of multiple software applications onboard the vehicle 10. By way of illustration, the work vehicle 10 is exemplarily configured as a crawler dozer. However, it is to be understood that the work vehicle 10 may take a variety of forms including, without limitation, other types of construction vehicles, forestry vehicles, and agricultural vehicles. In the illustrative example, the vehicle 10 has an operator's station 14 from where an operator controls operation of the vehicle 10 including various functions (e.g., the blade 16 of a crawler dozer) thereof.

Referring to FIG. 2, the software application display management system 12 is responsible for managing display of various software applications on a display screen 18 located at the operator's station 14. The system 12 has a controller 20 coupled to an input device 22 and the display screen 18. The controller 20 has a processor 23 and a memory 24 coupled to the processor 23. Stored in the memory 24 are operating instructions 25 for controlling operation of the processor 23 and multiple application groups such as application group A and application group B. Of course, there may be more than just two groups of applications; but, by way of example in the description below, it is assumed that there are two groups.

Each application group A and B includes multiple software applications. For example, application group A has applications A₁ to Aₘ and application group B has applications B₁ to Bₘ. The applications of each application group A, B are stored, for example, in a circular buffer (i.e., a circular buffer for group A and a circular buffer for group B) such that the applications thereof are “listed” in a predetermined switching order, the significance of which is discussed in more detail below. The memory 24 containing the operating instructions and the groups A, B may be provided on any suitable computer-readable medium.

The controller 20 is responsive to input signal requests generated upon actuation of the input device 22 to control which application group is selected among the application groups A and B and to control which application of the selected application group is in focus on the display screen 18. The term “focus” as used herein means the application is displayed on the display screen 18 and, in the case where at least two applications are running concurrently, is the application which is in the foreground of the display screen 18 relative to the other concurrently running application(s) and is ready for input from the operator (if the application is of the type that can receive operator inputs).

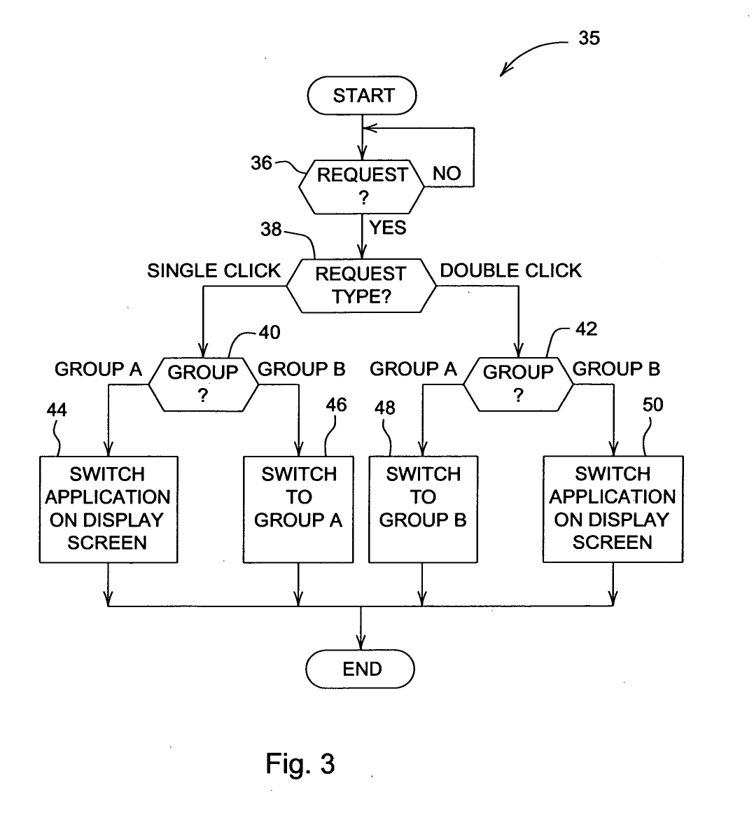

The operating instructions 25 are executable by the processor 23 to cause the processor 23 to perform various functions. Such functions include switching which application is in focus on the display screen 18 between applications of the selected application group A or B according to the predetermined switching order in response to actuation of the input device 22, and switching which application group A, B is the selected application group between the application groups A and B in response to actuation of the input device 22. Operation of processor 23 per the operating instructions 25 is illustrated in FIG. 3.

Referring to FIG. 3, there is shown an exemplary control routine 35 of the operating instructions 25 for managing display of the applications on the display screen 18. At step 36, the processor 23 monitors output of the input device 22 for request signals generated upon actuation of the input device 22. If no request signal is detected, the routine 35 cycles back to the start. If a request signal is detected, the routine 35 advances to step 38.

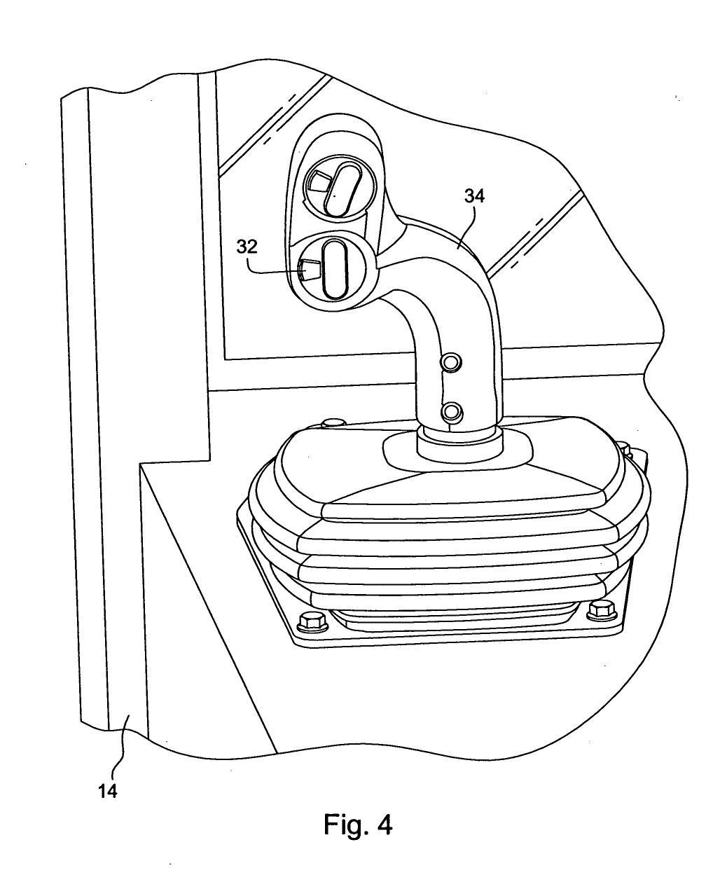

Actuation of the input device 22 may occur in a variety of ways depending on the type of input device 22 employed. Illustratively, as shown in FIG. 4, the input device 22 may be a “screen-swap” button 32 on a joystick 34 located at the operator's station 14, the button 32 being one of possibly several buttons on the joystick 34, each responsible for controlling a function of the vehicle 10. In such a case, the vehicle operator may “click” the button 32 in a predetermined manner to actuate it. For example, the operating instructions 25 may be such that single and double clicks of the button 32 are understood to initiate performance of different functions as described in more detail below. In other examples, the input device 22 may be configured so as to be actuable in a variety of other ways such as, without limitation, optically-actuated, sound-actuated (e.g., voice), motion-actuated, position-actuated, speed-actuated, or GPS or laser-actuated. Stated otherwise, the stimuli for actuating the input device 22 may come from external event(s), operator input(s), communication record(s), sampled value(s), or combinations thereof, to name just a few possibilities. The input device 22 may be configured so as to be responsive to a variety of stimuli such as external events, operator inputs, Further, the joystick may be connected directly to the controller 20 via a communication link (e.g., a CAN bus) or connected to another onboard controller (e.g., a hydraulic control unit) which is in turn connected to the controller 20 via the communication link.

At step 38, the control routine 35 determines the type of request represented by the request signal received. In particular, the routine 35 determines whether the input device 22 has been actuated in a first manner representative of a first request type or a second manner representative of a second request type. In the case where the input device 22 is exemplarily the button 32, the first manner may be a single click of the button 32 and the second manner may be a double click of the button 32. In such a case, the control routine advances to step 40 if the request type is a single click or to step 42 if the request type is a double click.

At step 40, the control routine 35 determines which group is currently activated. If group A is currently activated, at step 44 the routine 35 responds to a single click by switching the application in focus on the screen 18 between applications of group A according to the predetermined switching order. For example, if application A₁ were in focus before the request, the routine 35 would switch the application in focus from application A₁ to application A₂. Successive single clicks of the button 32 would switch the application in focus to the application next in order until Aₘ is reached after which the switching order would cycle back to A₁, consistent with operation of a circular buffer.

On the other hand, if group B is currently activated, at step 46 the routine 35 responds to a single click by switching the activated group from group B to group A. Successive single clicks of the button 32 would then switch the application in focus from one application of group A to the next.

At step 42, the control routine 35 determines which group is currently activated. If group A is currently activated, at step 48 the routine 35 responds to a double click by switching the activated group from group A to group B. Successive double clicks of the button 32 would then switch the application in focus from one application of group B to the next.

On the other hand, if group A is currently activated, at step 50 the routine 35 responds to a double click by switching the application in focus on the display screen 18 between applications of group B according to the predetermined switching order. For example, if application B₁. Were in focus before the request, the routine 35 would switch the application in focus from application B₁ to application B₂. Successive double clicks of the button 32 would switch the application in focus to the application next in order until Bₙ is reached after which the switching order would cycle back to B₁, consistent with operation of a circular buffer.

Thus, as an example, at start-up of the vehicle 10, group A may be initiated as the activated group. The operator may switch the application in focus between applications of group A by successive single clicks of the button 32. When the operator desires to switch to group B, the operator may double click the button 32 to switch from group A to group B after which the operator may switch the application in focus between applications of group B by successive double clicks of the button 32. The operator may then single click the button 32 to return from group B to group A, after which the application in focus may be switched between applications of group A by successive single clicks.

The applications of a particular group may be related in some manner as determined, for example, by the operator, manufacturer, or other scheme. For example, the applications of group A may be characterized as “real-time” applications that may be germaine to operation of the vehicle. Examples of such applications include, but are not limited to, instrument emmulation applications, worksite maps, and on-board camera applications for viewing images from onboard cameras, to name just a few. The applications of group B may be characterized as support or post-processing applications. Applications that fall into this category include, but are not limited to, operator training applications (e.g., videos, parts manuals), machine health applications, and machine operational history applications, to name just a few. As such, the applications may be categorized into intuitive groups for ease of use.

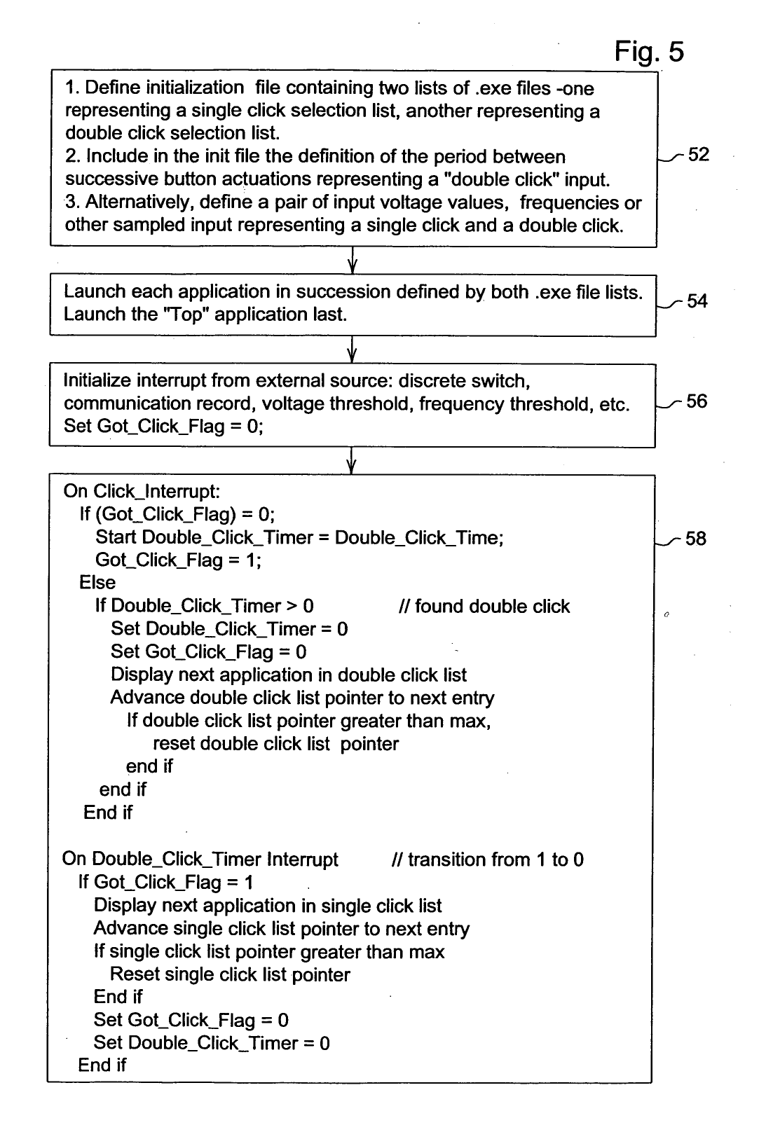

FIG. 5 illustrates a flowchart for implementing aspects of an exemplary routine. In block 52, an initialization file containing groups A and B (i.e., the “two lists”) is defined. The successive-click time period for establishing what input qualifies as a double click is also defined. Alternatively, other criteria may be used for defining single and double clicks. In block 54, the applications of each group are launched according to the predetermined switching order defined by each .exe file list. In block 56, what qualifies as a request for a group or application switch is defined. In block 58, partially coded steps are provided, non-coded portions being described narratively, the coding of which would be evident to those of ordinary skill in the art.

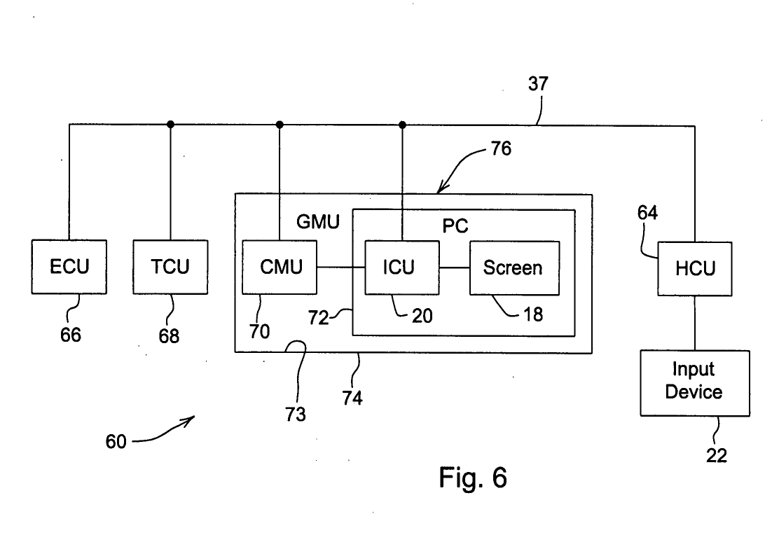

Referring to FIG. 6, there is shown a network 60 of electronic control units onboard the vehicle 10. The electronic control units are connected for communication via a communications link 62 such as the tractor CAN bus 62. The network 60 includes, for example, a hydraulics control unit 64 (“HCU”) for controlling various hydraulic functions of the vehicle 10 (e.g., blade and non-blade functions). The network 60 further includes an electronic engine control unit 66 (“ECU”) for controlling the vehicle engine, an electronic transmission control unit 68 (“TCU”) for controlling the vehicle transmission, and an electronic CAN monitor unit 70 (“CMU”) for monitoring basic tractor functions (e.g., fuel level, oil level) of the vehicle 10. The CMU 70 is coupled to the electronic controller 20 (which may be referred to as an electronic operator-interface control unit or “ICU”). Such coupling may be via, for example, a high speed serial interface to supply display data from the CMU 70 to the ICU 20 for display on the screen 18. Together, the ICU 20 and the display screen 18 provide a personal computer 72 (“PC”) for interface with the operator. Further, for space economy purposes, the CMU 70 and the PC 45 may be physically contained in the interior region 73 of a common housing 74, providing what may be termed as a graphical monitor unit 76 (“GMU”) located in a console (e.g., front console) of the operator's station 14.

The CMU 70 encodes function-monitoring data and transmits such data to the ICU 20 for display on the screen 18. Exemplarily, the CMU 70 is a 16-bit microprocessor. The CMU 70 is configured such that it is operational virtually instantaneously at start-up of the vehicle 10 whereas the ICU 20 may have a boot-up time period after start-up. Thus, because of the instantaneous or near-instantaneous start-up of the CMU 70 with vehicle start-up, the vehicle 10 may be used right away at vehicle start-up, reducing sensitivity that an operator may have to the boot-up time period of the ICU 20. By co-locating the PC 72 with the CMU 70, the input/output functions are tended by the CMU 70 without the need tomodify harnesses from the tractor of the vehicle 10 and without loosing boot time or requiring modification of other system controllers (e.g., microcontrollers) such as the ECU 66, the TCU 68, or other electronic control units.

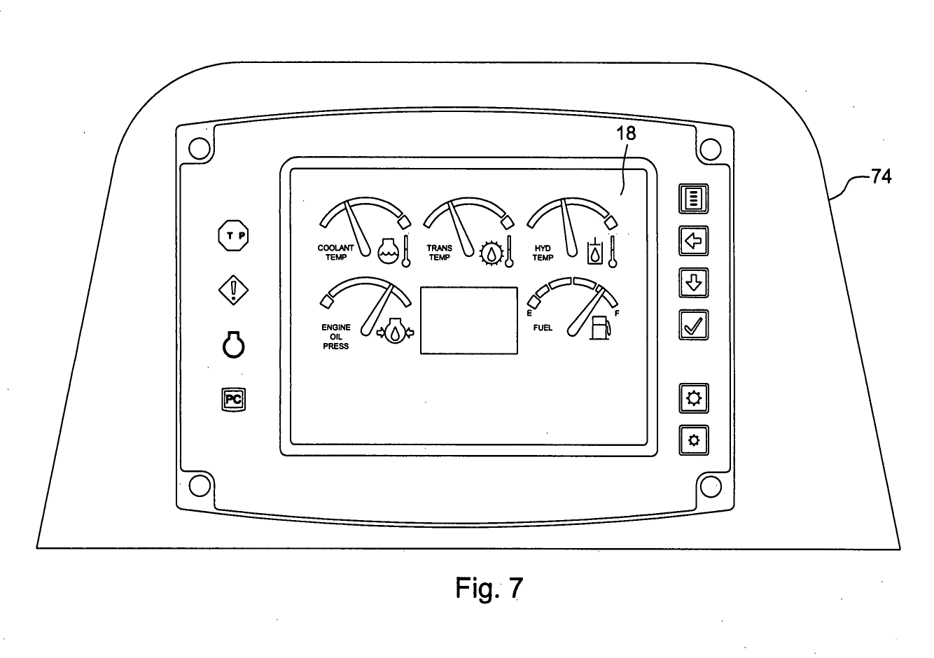

The ICU 20 is responsible for controlling what is displayed on the screen 18, including the the various software applications stored in its memory 24. As alluded to above, multiple software applications may be stored in the memory 24 for selective display on the screen 18. More than one of these applications may run concurrently. The ICU 20 controls which of the multiple software applications is displayed on the screen 18 at any given time. Exemplarily, only one application may be displayed at a time on the screen 18 (e.g., see FIG. 7 showing an instrument emmulation package displayed on the screen 18). In other examples, the ICU 20 may be configured such that more than one application or icons representative thereof may be displayed on the screen 18 simultaneously, with only one of them being in focus on the screen 18 at any given moment. Thus, the single screen 18 may be used to display not only the instrument emmulation software (see FIG. 7) but also various other software applications stored in the memory 24 (or even elsewhere) as well, thereby enhancing use of the limited space in the operator's station.

The PC 72 may have a number of interfaces for connection with a variety of systems. The PC 72 may have, for example, RS232 communication ports, USB communication ports, and/or an Ethernet port to facilitate growth into future applications and/or usage of currently installed applications. Possible examples include, but are not limited to, embedded operator training, Internet at the operator's station (i.e., in the cab), machine health monitoring, and remote machine information. The network developed around the PC architecture can thus be readily utilized at relatively low cost.

The input device 22 is exemplarily coupled to the HCU 64 to provide input signals thereto in response to actuation of the input device 22 by the operator. In response to toggling of the device 22, the application switch state associated with such toggling is encoded in a CAN message from the HCU 64 to the remaining nodes of the network 60. The output is initialized to 0 and then toggled between 0 and 1 or 1 and 0 with each actuation of the input device (e.g., pressing of the button). The HCU 64 transmits the application switch state periodically. The ICU 20 is responsive to such toggling of the switch state to change the application in focus on the screen 18.

While the disclosure has been illustrated and described in detail in the drawings and foregoing description, such an illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A method of operating a work vehicle, comprising:
switching which application is in focus on a display screen of the work vehicle between applications of a selected application group of multiple application groups stored in a memory of the work vehicle according to a predetermined switching order in response to actuation of an input device, each application group comprising multiple applications, and
switching which application group is the selected application group between application groups of the multiple application groups stored in the memory of the work vehicle in response to actuation of the input device.

2. The method of claim 1, wherein:
switching which application is in focus comprises actuating the input device in a first manner, and
switching which application group is the selected application group comprises actuating the input device in a second manner.

3. The method of claim 1, wherein:
the multiple application groups comprise a first application group and a second application group, and
switching which application is in focus comprises actuating the input device in a first manner so as to switch which application of the first application group is in focus on the display screen when the first application group is selected and actuating the input device in a second manner so as to switch which application of the second application group is in focus on the display screen when the second application group is selected.

4. The method of claim 1, wherein:
the input device comprises a button,
the multiple application groups comprise a first application group and a second application group,
switching which application is in focus comprises switching which application of the first application group is in focus on the display screen in response to a single operation of the button,
switching which application group is the selected application group comprises switching the selected application group from the first application group to the second application group such that the second application group becomes the selected application group in place of the first application group in response to a double operation of the button,
switching which application is in focus comprises switching which application of the second application group is in focus on the display screen in response to a double operation of the button, and
switching which application group is the selected application group comprises switching the selected application from the second application group back to the first application group such that the first application group becomes the selected application group in place of the second application group in response to a single operation of the button.

5. A work vehicle, comprising:
an input device,
a display screen, and
a controller coupled to the input device and the display screen, the controller comprising a processor and a memory coupled to the processor, the memory having stored therein operating instructions which, when executed by the processor, cause the processor to:
switch which application is in focus on the display screen between applications of a selected application group of multiple application groups stored in the memory of the work vehicle according to a predetermined switching order in response to actuation of the input device, each application group comprising multiple applications, and
switch which application group is the selected application group between application groups of the multiple application groups stored in the memory of the work vehicle in response to actuation of the input device.

6. The work vehicle of claim 5, wherein the application groups are stored in respective circular buffers of the memory.

7. The work vehicle of claim 5, wherein the operating instructions, when executed by the processor, cause the processor to:
switch which application is in focus on the display screen in response to a first manner of actuation of the input device, and
switch which application group is the selected application group in response to a second manner of actuation of the input device.

8. The work vehicle of claim 5, wherein:
the multiple application groups comprise a first application group and a second application group, and
the operating instructions, when executed by the processor, cause the processor to:
switch which application is in focus on the display screen between applications of the first application group in response to a first manner of actuation of the input device, and
switch which application is in focus on the display screen between applications of the second application group in response to a second manner of actuation of the input device.

9. The work vehicle of claim 5, wherein:
the input device comprises a button, and
the multiple application groups comprise a first application group and a second application group, and
the operating instructions, when executed by the processor, cause the processor to:
switch which application is in focus on the display screen between applications of the first application group in response to a single operation of the button,
switch the selected application group from the first application group to the second application group such that the second application group becomes the selected application group in place of the first application group in response to a double operation of the button,
switch which application is in focus on the display screen between applications of the second application group in response to a double operation of the button, and
switch the selected application group from the second application group back to the first application group such that the first application group becomes the selected application group in place of the second application group in response to a single operation of the button.

10. The work vehicle of claim 5, wherein the input device is button mounted in an operator station of the work vehicle.

11. The work vehicle of claim 10, wherein the button is mounted on a joystick located at an operator's station of the work vehicle.

12. The work vehicle of claim 5, wherein the multiple application groups comprise a first application group comprising multiple concurrently-executing applications and a second application group comprising multiple other applications.

13. A computer-readable medium for use with a work vehicle, the computer-readable medium comprising operating instructions which, when executed by a processor, cause the processor to:
switch which application is in focus on a display screen of the work vehicle between applications of a selected application group of multiple application groups stored in a memory of the work vehicle according to a predetermined switching order in response to actuation of an input device, each application group comprising multiple applications, and
switch which application group is the selected application group between application groups of the multiple application groups stored in the memory of the work vehicle in response to actuation of the input device.

14. The computer-readable medium of claim 13, wherein the operating instructions, when executed by the processor, cause the processor to:
switch which application is in focus on the display screen in response to a first manner of actuation of the input device, and
switch which application group is the selected application group in response to a second manner of actuation of the input device.

15. The computer-readable medium of claim 13, wherein:
the multiple application groups comprise a first application group and a second application group, and
the operating instructions, when executed by the processor, cause the processor to:
switch which application is in focus on the display screen between applications of the first application group in response to a first manner of actuation of the input device, and
switch which application is in focus on the display screen between applications of the second application group in response to a second manner of actuation of the input device.

16. The computer-readable medium of claim 13, wherein:
the input device comprises a button, and
the multiple application groups comprise a first application group and a second application group, and
the operating instructions, when executed by the processor, cause the processor to:
switch which application is in focus on the display screen between applications of the first application group in response to a single operation of the button,
switch the selected application group from the first application group to the second application group such that the second application group becomes the selected application group in place of the first application group in response to a double operation of the button,
switch which application is in focus on the display screen between applications of the second application group in response to a double operation of the button, and
switch the selected application group from the second application group back to the first application group such that the first application group becomes the selected application group in place of the second application group in response to a single operation of the button.
